(19) United States
(12) Patent Application Publication
(10) Pub. No.: US 2014/0062431 A1
(43) Pub. Date: Mar. 6, 2014

(54) DC-DC CONVERTER AND SEMICONDUCTOR DEVICE

(71) Applicant: KABUSHIKI KAISHA TOSHIBA, Tokyo (JP)

(72) Inventors: Kaoru YANASE, Kanagawa (JP); Kei Kasai, Kanagawa (JP)

(73) Assignee: Kabushiki Kaisha Toshiba, Tokyo (JP)

(21) Appl. No.: 13/754,114

(22) Filed: Jan. 30, 2013

(30) Foreign Application Priority Data
Sep. 4, 2012 (JP) 2012-194081

(51) Int. Cl. G05F 1/46

(52) U.S. Cl. CPC G05F 1/46
USPC 323/271

(57) ABSTRACT

A DC-DC converter includes an input terminal connected to one end of a boot capacitor and a boot terminal connected to the other end of the boot capacitor. A first transistor has a drain connected to the input terminal and a source connected to a switch terminal. A second transistor has a drain connected to the switch terminal and a source connected to ground. Agate of the first transistor is connected to a first driver circuit, which is connected to the boot capacitor. A gate of the second transistor is connected to a second driver circuit. The DC-DC converter includes an oscillator circuit outputting a pulse signal and a voltage detecting circuit which detects the voltage of the boot capacitor. The voltage detecting circuit outputs a signal based on the detected voltage. A timing circuit controls the first and second drivers in accordance with the detected voltage signal.

### CROSS-REFERENCE TO RELATED APPLICATION

This application is based upon and claims the benefit of priority from Japanese Patent Application No. 2012-194081, filed Sep. 4, 2012, the entire contents of which are incorporated herein by reference.

### FIELD

Embodiments described herein relate the DC-DC converter and semiconductor device.

### BACKGROUND

The on-duty of a step-down (buck) DC-DC converter is determined by the ratio between the input voltage and output voltage.

For this reason, in the DC-DC converter, when the difference between the input voltage and output voltage is reduced, the on-duty is increased. That is to say, the high-side switch-on time becomes longer, and the low-side switch-off time becomes shorter.

In the case of the DC-DC converter using the bootstrap method, it is necessary to charge the bootstrap capacitor during the period when the high-side switch is off and the low-side switch is on.

For this reason, generally the control method of limiting the on-duty (i.e., fixing the low side switch on-time) is used.

In the case of this control method, considering the variation of capacity of the bootstrap capacitor that is applicable in the DC-DC converter, and considering the capability for the charging power of the bootstrap capacitor, it is necessary to set the duration of the high-side switch-off time and the low-side switch-on time.

Therefore, in the DC-DC converter that applied the control method, the on-duty is limited, and the difference between input voltage and output voltage is also limited. Thus, for the conventional buck DC-DC converter, the operating range is limited.

### DESCRIPTION OF THE DRAWINGS

FIG. 1 is a block diagram depicting the structure of a DC-DC converter incorporating a semiconductor device according to a first embodiment.

FIG. 2 is a waveform diagram showing an example of the operation waveforms of a DC-DC converter with a semiconductor device of the first embodiment.

FIG. 3 is a block diagram depicting a DC-DC converter incorporating a semiconductor device according to a second embodiment.

FIG. 4 is a waveform diagram showing an example of the operation waveforms of a DC-DC converter incorporating a semiconductor device of the second embodiment.

### DETAILED DESCRIPTION

The present disclosure describes a DC-DC converter and semiconductor device with an expanded operating range. In general, example embodiments will be explained with references to the figures.

A DC-DC converter according to an embodiment includes an input terminal to which the power supply voltage is applied. The DC-DC converter includes a switch terminal that connects to the terminal of a boot capacitor. The DC-DC converter is also equipped with a boot terminal that connects to the other end of the boot capacitor.

The DC-DC converter includes a first nMOS transistor having a drain connected to the input terminal and a source connected to the switch terminal. The DC-DC converter also includes a second nMOS transistor having a drain connected to the switch terminal and a source connected to the ground.

The DC-DC converter further includes a first driver that uses the boot capacitor as the power source for driving, outputs a first gate drive signal to the gate of the first nMOS transistor, and controls the operation of the first nMOS transistor. Additionally, the DC-DC converter includes a second driver that outputs a second gate drive signal to the gate of the second nMOS transistor and that controls the operation of the second nMOS transistor.

The DC-DC converter further includes an oscillator circuit that outputs a pulse signal, a voltage detecting circuit that detects the charging voltage at which the boot capacitor is charged and outputs the voltage detection signal on the basis of the detection result, and a timing control circuit that controls the operation of the first driver and the second driver through the control signal in accordance with the pulse signal and the detection result.

### First Embodiment

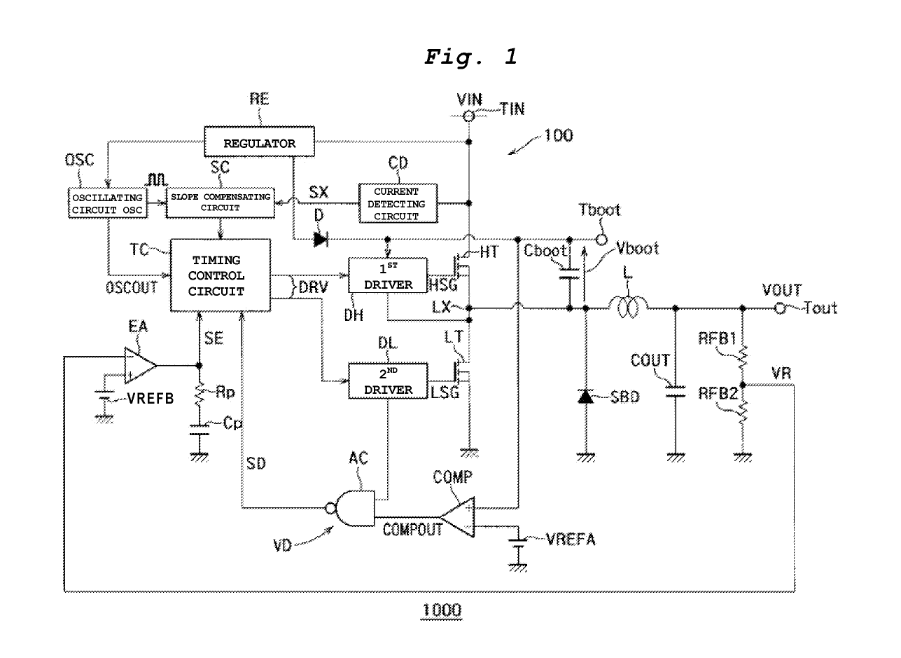

FIG. 1 is a block diagram showing an example of the structure of a DC-DC converter 1000 that includes a semiconductor device 100 of the first embodiment. The DC-DC converter 1000 that is shown in FIG. 1 is a buck DC-DC converter that employs the bootstrap method.

As shown in FIG. 1, the DC-DC converter 1000 includes an output terminal Tout, a coil L, an output capacitor COUT, a Schottky-barrier diode SBD, a boot capacitor Cboot, a first voltage dividing resistor RFB1, and a second voltage dividing resistor RFB2, all of which are implemented as the semiconductor device 100.

For the coil L, a first end is connected to the output terminal Tout. The output capacitor COUT is connected between the first end of the coil L and the ground. For the Schottky barrier diode SBD, its cathode is connected to a second end of the coil L, and its anode is connected to the ground. For the boot capacitor Cboot, a first end is connected to the second end of the coil L. For a first voltage dividing resistor RFB1, a first end is connected to the output terminal Tout. For a second voltage dividing resistor RFB2, a first end is connected to a second end of the first voltage dividing resistor RFB1 and a second end is connected to the ground.

Moreover, as shown in FIG. 1, the semiconductor device 100 has an input terminal TIN to which a power supply voltage VIN is applied, a boot terminal Tboot that is connected to a second end of the boot capacitor Cboot, and a switch terminal LX that is connected to the second end of the coil L.

The semiconductor device 100, as shown in FIG. 1, also has a first nMOS transistor (the high-side switch) HT at the high side, a second nMOS transistor (the low-side switch) LT at the low side, an oscillator circuit OSC, a first driver DH, a second driver DL, a regulator RE, a diode D, a voltage detecting circuit VD, a timing control circuit TC, a current detecting circuit CD, a slope compensating circuit SC, an error amplifier circuit EA, a resistor Rp, and a capacitor Cp.

From the power supply voltage VIN of the input terminal TIN, the regulator RE can generate and output a voltage lower than the power supply voltage VIN (the voltage output by the regulator through the diode D sometimes being referred to herein as an internal voltage). For the diode D, its anode is connected to the output of regulator, and its cathode is connected to the boot terminal Tboot.

In this way, from the regulator RE, through the diode D, an internal voltage that is lower than the power supply voltage VIN is applied to the boot terminal Tboot. In addition, the internal voltage is set to a value that does not exceed the gate voltage resistance of an nMOS transistor to be used, and generally it is set to about 5V. Furthermore, the regulator RE provides a generated voltage as the driving voltage for driving the oscillator circuit OSC.

For the first nMOS transistor HT, its drain is connected to the output terminal TIN, and its source is connected to the switch terminal LX. For the second nMOS transistor LT, its drain is connected to the switch terminal LX, and its source is connected to the ground.

The first driver DH uses the boot capacitor Cboot as the power source for driving, outputs the first gate drive signal HSG to a gate of the first nMOS transistor HT, and thereby controls the operation of the first nMOS transistor HT. Additionally, the second driver DL outputs the second gate drive signal LSG to a gate of the second nMOS transistor LT and thereby controls the operation of the second nMOS transistor LT. For example, this second driver DL uses the internal voltage lower than the power supply voltage VIN for driving. The oscillator circuit OSC outputs the pulse signal OSCOUT.

The voltage detecting circuit VD detects the voltage Vboot to which the boot capacitor Cboot is charged and outputs the voltage detection signal SD on the basis of the detection result.

The timing control circuit TC controls the operation of the first driver DH and the second driver DL by the control signal DRV in accordance with the pulse signal OSCOUT and the detection result of the voltage detecting circuit VD. In particular, in accordance with the voltage detection signal SD showing that the charging voltage Vboot is higher than the boot standard voltage VREFA, the timing control circuit TC uses the boot capacitor Cboot as the power supply to drive the first driver DH.

Here, for example, as shown in FIG. 1, the voltage detecting circuit VD includes a comparator COMP and an arithmetic circuit AC. The comparator COMP compares the voltage of the boot terminal Tboot with the boot standard voltage VREFA and outputs the comparison result signal COMPOUT based on the comparison.

The arithmetic circuit AC outputs the voltage detection signal SD that is a signal corresponding to a calculation on signal COMPOUT and the second gate drive signal LSG. This arithmetic circuit AC is, for example, a NAND circuit.

When the second nMOS transistor LT is controlled by the second gate drive signal LSG that is at a “High” level, the arithmetic circuit AC outputs the voltage detection signal SD that is at a “Low” level only when the voltage of the boot terminal Tboot is higher than the boot standard voltage VREFA (i.e., in the case when the comparison result signal COMPOUT is also at a “High” level). On the other hand, when the second nMOS transistor LT is controlled by the second gate drive signal LSG that is at a “Low” level, the arithmetic circuit AC outputs the voltage detection signal SD that is at a “High” level, regardless of the boot terminal Tboot voltage (regardless of the comparison result signal COMPOUT).

When the voltage detection signal SD is at the “Low” level, the timing control circuit TC recognizes that the charging voltage Vboot is higher than the boot standard voltage VREFA. On the other hand, when the voltage detection signal SD is at the “High” level, the timing control circuit TC will not use the detection result of the voltage detecting circuit VD.

The voltage of the boot terminal Tboot will vary in accordance with the operation state of the first and second nMOS transistor HT and LT. That is to say, the voltage of the boot terminal Tboot will not be always equivalent to the charging voltage Vboot of the boot capacitor Cboot. However, when the second nMOS transistor LT is controlled to be in an ON state by the second gate drive signal LSG, one end of the boot capacitor Cboot becomes the grounding electric potential. At this time, the voltage of the boot terminal Tboot is equivalent to the value of charging voltage Vboot of the boot capacitor Cboot. Therefore, the comparison result signal COMPOUT is equivalent to a comparison between the charging voltage Vboot and the boot standard voltage VREFA.

Moreover, the current detecting circuit CD detects the current flow of the first nMOS transistor HT and outputs the current detecting signal SX based on this detection result. The slope compensating circuit SC compensates for the slope based on the signal of the current detecting signal SX. Furthermore, the error amplifier circuit EA outputs the error signal SE that corresponds to the error of the output of standard voltage VREFB and the divided voltage VR from between the first voltage dividing resistance(resistor) RFB1 and second voltage dividing resistor RFB2.

For the resistor Rp, one end is connected to the output of the error amplifier circuit EA. For the capacitor Cp, one end is connected to the other end of the resistor Rp, and the other end of capacitor Cp is connected to the ground. Furthermore, in accordance with the error signal SE, the timing control circuit TC outputs the control signal DRV so that the divided voltage VR is equal to the output standard voltage VREFB.

In this way, the first and second drivers DH and DL control the operation of the first and second nMOS transistors HT and LT, respectively, so that the output voltage VOUT of the output terminal Tout is equal to a target value.

When the voltage of switch terminal LX is at a “Low” level (i.e., the first nMOS transistor HT is off, and the second nMOS transistor LT is on), the DC-DC converter 1000 with the structure using the bootstrap method charges the boot capacitor Cboot. On the other hand, when the voltage of the switch terminal LX is at a “High” level (i.e., the first nMOS transistor HT is on, and the second nMOS transistor LT is off), and when the charging voltage Vboot of the boot capacitor Cboot is higher than the boot standard voltage VREFA, the DC-DC converter 1000 uses the electric charge that is saved in the boot capacitor Cboot as the power supply of the first driver DH.

In this way, it is possible to use the first nMOS transistor HT as the high-side switch. Thus, as compared to the case when the pMOS transistor is used as the high-side switch, it is possible to lower the on-resistance or reduce the element size.

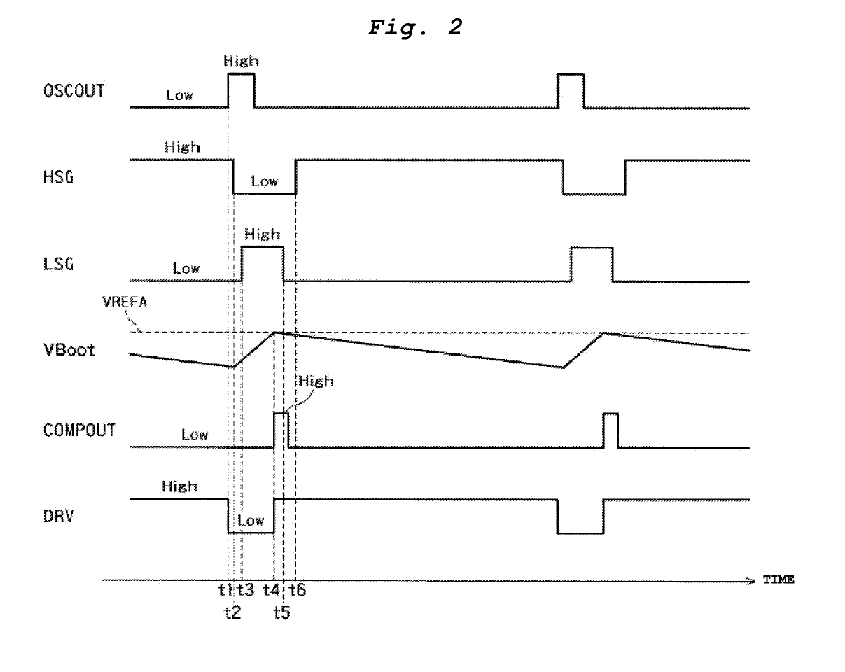

The following is the description of one example of the operation of the DC-DC converter 1000 that has the structure described above. Here, FIG. 2 is a waveform diagram showing an example of the operation waveforms of the DC-DC converter 1000 that is shown in FIG. 1.

As shown in FIG. 2, before the time of t1, the first gate drive signal HSG is at a “High” level, and the second gate drive signal LSG is at a “Low” level; the first nMOS transistor HT is on, and the second nMOS transistor LT is off.

At the time of t1, the oscillator circuit OSC outputs the pulse signal OSCOUT. In this way, the pulse signal OSCOUT is changed to the first level (the “High” level) from the second level (the “Low” level) that is lower than the first level. Corresponding to the transition of this pulse signal OSCOUT, the timing control circuit TC changes the control signal DRV from a “High” level to a “Low” level. As a result, the first driver DH changes the first gate driver signal HSG to a “Low” level and turns off the first nMOS transistor HT (time of t2).

That is to say, from the state where the first nMOS transistor HT is on and the second nMOS transistor LT is off, as the pulse signal OSCOUT is changed to the first level (the “High” level), the timing control circuit TC stops the driving current to the first driver DH and uses the first driver DH (the first gate driver signal HSG is changed to a “Low” level) to turn off the first nMOS transistor HT. As a result, the charging of the boot capacitor Cboot is resumed, and the charging voltage Vboot is increased.

After that, at the time of t3, the timing control circuit TC uses the second driver DL to change the second drive signal LSG to a “High” level and to turn on the second nMOS transistor LT. At this time, the comparison result signal COMPOUT of the comparator COMP is reflected in the voltage detection signal SD. Then, at the time of t4, when the voltage of the boot terminal Tboot is higher than the boot standard voltage VREFA, the comparator COMP changes the comparison result signal COMPOUT to a “High” level. Consequently, because the second gate drive signal LSG is at a “High” level, the arithmetic circuit AC outputs the voltage detection signal SD at a “Low” level indicating that the charging voltage Vboot is higher than the boot standard voltage VREFA.

When the voltage detection signal SD shows that the charging voltage Vboot is higher than the boot standard voltage VREFA, the timing control circuit TC drives the first driver DH using the boot capacitor Cboot as the power supply. The charging of the boot capacitor Cboot is stopped because the first driver DH is provided with the driving current, and the charging voltage Vboot is decreased.

Next, at the time of t5, the timing control circuit TC uses the second driver DL to change the second gate drive signal LSG to a “Low” level and to turn off the second nMOS transistor LT. Then, at the time of t6, the timing control circuit TC uses the first driver DH to change the first gate drive signal HSG to a “High” level and to turn on the first nMOS transistor HT. Moreover, at this time, for the voltage of the boot terminal Tboot, as compared with the drain of the first nMOS transistor HT (switch terminal LX), only the charging voltage Vboot (nearly same as the boot standard voltage VREFA) is increased. Therefore, the first driver DH can more stably drive the gate of the first nMOS transistor HT using the boot capacitor Cboot as the power supply.

Thereafter, the same operation is repeated. In this way, the DC-DC converter 1000 outputs the constant output voltage VOUT from the output terminal Tout.

Through the operation of the DC-DC converter 1000, the time needed to turn off the first nMOS transistor HT is even shorter than the time needed for charging the boot capacitor Cboot. That is to say, after the voltage detecting circuit has detected that the charging voltage Vboot has increased to the boot standard voltage VREFA, the DC-DC converter 1000 performs the function necessary to start the next cycle. In this way, because it is not necessary to consider the charging time of the boot capacitor Cboot and set the start time of next cycle, it is possible to set the operating range widely. (Second embodiment)

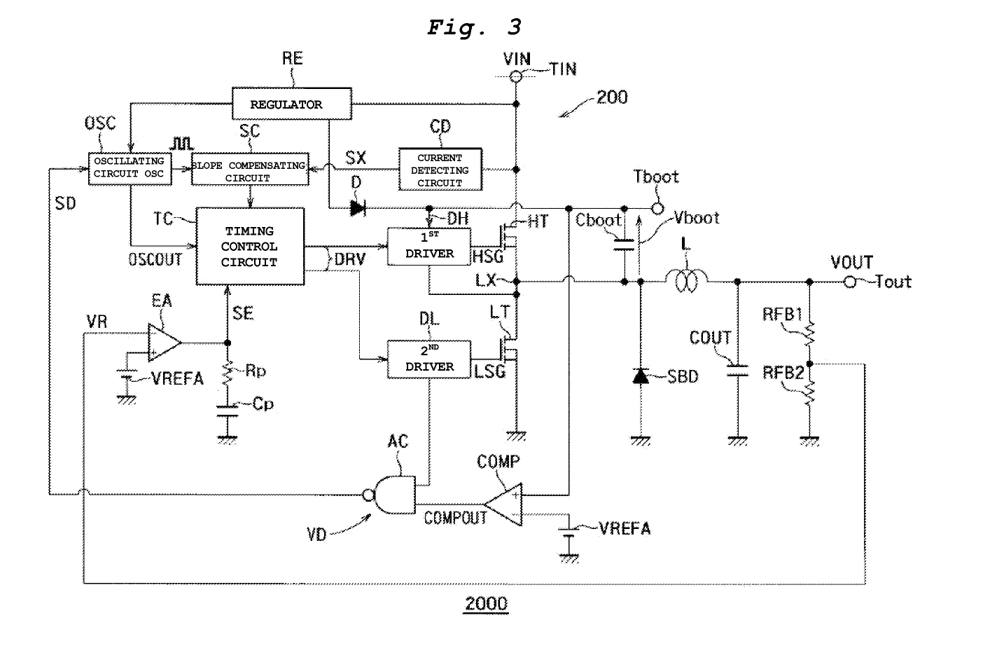

FIG. 3 is a block diagram showing an example of the structure of a DC-DC converter 2000 that includes a semiconductor device 200 according to the second embodiment. Moreover, in FIG. 3, the symbols used to reference specific parts will be the same as those used in FIG. 1.

As shown in FIG. 3, the DC-DC converter 2000 includes the output terminal Tout, the coil L, the output capacitor COUT, the Schottky-barrier diode SBD, the boot capacitor Cboot, the first voltage dividing resistor RFB1, the second voltage dividing resistor RFB2, and the semiconductor device 200.

Moreover, as shown in FIG. 3, and similar to the first embodiment, the semiconductor device 200 has the input terminal TIN to which the power supply voltage VIN is applied, the boot terminal Tboot that is connected to the other end of the boot capacitor Cboot, and the switch terminal LX that is connected to the other end of the coil L.

This semiconductor device 200, for example, as shown in FIG. 3, and similar to the first embodiment, has the first nMOS transistor (the high-side switch) HT at the high side, the second nMOS transistor (the low-side switch) LT at the low side, the oscillator circuit OSC, the first driver DH, the second driver DL, the regulator RE, the diode D, the voltage detecting circuit VD, the timing control circuit TC, the current detecting circuit CD, the slope compensating circuit SC, the error amplifier circuit EA, the resistor Rp, and the capacitor Cp.

Differently from the first embodiment, in which the voltage detection signal SD is input to the timing control circuit TC, in the second embodiment, the voltage detection signal SD is input to the oscillator circuit OSC.

In the second embodiment, after the pulse signal OSCOUT is changed to the first level (the “High” level), corresponding to the voltage detection signal SD indicating that the charging voltage Vboot is higher than the boot standard voltage VREFA, the oscillator circuit OSC changes the pulse signal OSCOUT to the second level (the “Low” level). As the pulse signal OSCOUT is changed to the second level (the “Low” level), the timing control circuit TC drives the first driver DH using the boot capacitor Cboot as the power supply.

The other structural features and functions of the DC-DC converter 2000 are same as those described in the first embodiment.

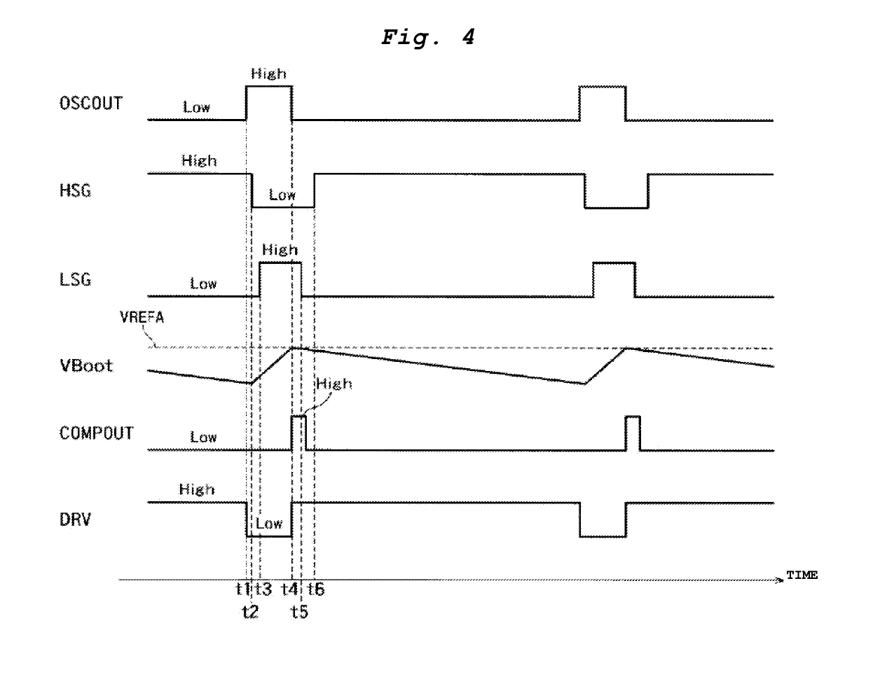

The following is the description of an example of the operation of the DC-DC converter 2000 that has the structure described above. FIG. 4 is a waveform diagram showing an example of the operation waveforms of the DC-DC converter 2000 that is shown in FIG. 3.

As shown in FIG. 4, and similar to the first embodiment, before the time of t1, the first gate drive signal HSG is at a “High” level, and the second gate drive signal LSG is at a “Low” level; the first nMOS transistor HT is on, and the second nMOS transistor LT is off.

At the time of t1, the oscillator circuit OSC outputs the pulse signal OSCOUT. In this way, the pulse signal OSCOUT is changed to the first level (the “High” level) from the second level (the “Low” level) that is lower than the first level. Corresponding to the transition of this pulse signal OSCOUT, the timing control circuit TC change the control signal DRV from a “High” level to a “Low” level. In this way, the first driver DH changes the first gate driver signal HSG to a “Low” level and turns off the first nMOS transistor HT (time of t2).

Thus, as in the first embodiment, from the state in which the first nMOS transistor HT is on and the second nMOS transistor LT is off, as the pulse signal OSCOUT is changed to the first level (the “High” level), the timing control circuit TC stops the driving current to the first driver DH and uses the first driver DH (turns the first gate driver signal HSG to a “Low” level) to turn off the first nMOS transistor HT. As a result, the charging of the boot capacitor Cboot is resumed, and the charging voltage Vboot is increased.

After that, at the time of t3, as in the first embodiment, the timing control circuit TC uses the second driver DL to change the second drive signal LSG to a “High” level and to turn on the second nMOS transistor LT. At this time, the comparison result signal COMPOUT of the comparator COMP is reflected in the voltage detection signal SD. Then, at the time of t4, when the voltage of the boot terminal Tboot is higher than the boot standard voltage VREFA, the comparator COMP turns the comparison result signal COMPOUT to a “High” level. Therefore, because the second gate drive signal LSG is at a “High” level, the arithmetic circuit AC outputs the voltage detection signal SD at the “Low” level indicating that the charging voltage Vboot is higher than the boot standard voltage VREFA.

Here, in the second embodiment, as previously described, the voltage detection signal SD indicating that the charging voltage Vboot is higher than the boot standard voltage VREFA is supplied to the oscillator circuit OSC, which changes the pulse signal OSCOUT to the second level (the “Low” level) (time of t4). Then, as the pulse signal OSCOUT is changed to the second level (the “Low” level), the timing control circuit TC drives the first driver DH using the boot capacitor Cboot as the power supply. The charging of the boot capacitor Cboot is stopped because the first driver DH is provided with the driving current, and the charging voltage Vboot is decreased.

Next, at the time of t5, as in the first embodiment, the timing control circuit TC uses the second driver DL to turn the second gate drive signal LSG to a “Low” level and to turn off the second nMOS transistor LT. Then, at the time of t6, the timing control circuit TC uses the first driver DH to change the first gate drive signal HSG to a “High” level and to turn on the first nMOS transistor HT.

Moreover, at this time, for the voltage of the boot terminal Tboot, as compared with the drain of the first nMOS transistor HT (switch terminal LX), only the charging voltage Vboot (nearly same as the boot standard voltage VREFA) is increased. Therefore, the first driver DH can more stably drive the gate of the first nMOS transistor HT using the boot capacitor Cboot as the power supply.

Thereafter, the same operation is repeated. In this way, the DC-DC converter 2000 outputs the constant output voltage VOUT from the output terminal Tout.

Through the operation of the DC-DC converter 2000, the time needed to turn off (switch) the first nMOS transistor HT is even shorter than the time needed for charging the boot capacitor Cboot. That is to say, after the voltage detecting circuit VD detected that the charging voltage Vboot has increased to the boot standard voltage VREFA, the DC-DC converter 2000 performs the function necessary to start the next cycle.

In this way, because it is not necessary to consider the charging time of the boot capacitor Cboot, specifically, to determine the start time of the next cycle, it is possible to set the operating range widely.

The embodiments are examples only, and the scope of this disclosure is not limited to them.

In each embodiment, for the DC-DC converter using the bootstrap method, there is description of an example of the method that uses the boot capacitor Cboot as the power supply to charge the boot capacitor Cboot from the internal power supply (regulator) through a simple diode used to prevent the backflow.

However, for the power supply of the boot capacitor Cboot, the following methods can also be used: the method of charging from the external power supply through the diode used to prevent the backflow; the method of charging from the internal power supply through the diode used to prevent the backflow; the method of detecting the potential of the boot capacitor Cboot and then turning ON/OFF the internal power supply, and so on.

Moreover, in the embodiments, each signal level (logic) of the DC-DC converter is an example, and it is preferable to be able to perform the same operation even when each signal level (logic) is changed.

While certain embodiments have been described, these embodiments have been presented by way of example only, and they are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A DC-DC converter, comprising:
an input terminal to which a power supply voltage is to be applied;
a switch terminal that is connected to one end of a boot capacitor;
a boot terminal that is connected to the other end of the boot capacitor;
a first nMOS transistor having a drain connected to the input terminal and a source connected to the switch terminal;
a second nMOS transistor having a drain connected to the switch terminal and a source connected to ground;
a first driver connected to the boot capacitor and configured to output a first gate driving signal to a gate of the first nMOS transistor;
a second driver configured to output a second gate driving signal to a gate of the second nMOS transistor;
an oscillator circuit configured to output a pulse signal;
a voltage detecting circuit configured to detect a voltage to which the boot capacitor is charged and to output a voltage detection signal according to the detected voltage; and
a timing control circuit configured to control the first driver and second driver in accordance with the pulse signal and the detected voltage.

2. The DC-DC converter according to claim 1, wherein the voltage detection signal is supplied to the timing control circuit.

3. The DC-DC converter according to claim 1, wherein the voltage detection signal is supplied to the oscillator circuit.

4. The DC-DC converter according to claim 3, wherein the oscillator circuit switches the pulse signal to a second level when the voltage detection signal indicates that the voltage to which the boot capacitor is charged is higher than the boot reference voltage; and
the timing control circuit drives the first driver using the boot capacitor as the power supply when the pulse signal is switched to the second level.

5. The DC-DC converter according to claim 1, wherein the timing control circuit is configured to switch the first nMOS transistor from an ON state to an OFF state by controlling the first driver and to switch the second nMOS transistor from an OFF state to an ON state by controlling the second driver when the pulse signal is at a first level; and the boot capacitor supplies power to first driver when the voltage detection signal indicates that the voltage to which the boot capacitor is charged is higher than a boot reference voltage.

6. The DC-DC converter according to claim 1, wherein the timing control circuit drives the first driver using the boot capacitor as the power supply when the voltage detection signal indicates that the voltage to which the boot capacitor is charged is higher than a boot reference voltage.

7. The DC-DC converter according to claim 1, wherein the voltage detecting circuit comprises:
a comparator configured to compare a voltage at the boot terminal with a boot reference voltage and to output a comparison result signal based on the comparison; and
an arithmetic circuit configured to output the voltage detection signal corresponding to an arithmetic operation on the comparison result signal and the second gate driving signal.

8. The DC-DC converter according to claim 7, wherein the arithmetic circuit is further configured to output the voltage detection signal indicating that the voltage to which the boot capacitor is charged is higher than a boot reference voltage when the second nMOS transistor is controlled to be in an ON state by the second gate driving signal and the voltage to which the boot capacitor is charged is higher than the boot reference voltage.

9. The DC-DC converter according claim 1, further comprising:
a regulator configured to generate and output a voltage lower than the power supply voltage from the input terminal; and
a diode having an anode connected to the output of the regulator and a cathode connected to the boot terminal.

10. A semiconductor device including a DC-DC converter, comprising:
an input terminal to which a power supply voltage is to be applied;
a switch terminal that is connected to a first end of a boot capacitor;
a boot terminal connected to a second end of the boot capacitor;
a first nMOS transistor having a drain connected to the input terminal and a source connected to the switch terminal;
a second nMOS transistor having a drain connected to the switch terminal and a source connected to ground;
a first driver configured to use the boot capacitor as a power source and to output a first gate driving signal to a gate of the first nMOS transistor;
a second driver configured to output a second gate driving signal to a gate of the second nMOS transistor;
an oscillator circuit configured to output a pulse signal;
a voltage detecting circuit configured to detect the voltage to which the boot capacitor is charged and to output the voltage detection signal according to the detected voltage; and
a timing control circuit configured to control the first driver and the second driver in accordance with the pulse signal and the detected voltage.

11. The semiconductor device according to claim 10, wherein the timing control circuit is configured to switch the first nMOS transistor from an ON state to an OFF state by controlling the first driver and to switch the second nMOS transistor from an OFF state to an ON state by controlling the second driver when the pulse signal is at a first level; and the boot capacitor supplies power to first driver when the voltage detection signal indicates the voltage to which the boot capacitor is charged is higher than a boot reference voltage.

12. The semiconductor device according to claim 10, further comprising:
a current detecting circuit connected to the input terminal and configured to detect a current and generate a current detection signal in accordance with the detected current; and
a slope compensation circuit connected to the current detecting circuit and receiving the current detection signal and configured to supply a slope compensation signal to the timing control circuit.

13. The semiconductor device according to claim 10, wherein the voltage detection circuit comprises:
a comparator configured to compare the voltage at the boot terminal with a boot reference voltage and to output a comparison result signal based on the comparison; and
an arithmetic circuit configured to output the voltage detection signal corresponding to a calculation result on the comparison result signal and the second gate driving.

14. The semiconductor device according to claim 13, wherein the arithmetic circuit is further configured to output the voltage detection signal indicating that the voltage to which the boot capacitor is charged is higher than a boot reference voltage when the second nMOS transistor is controlled to be in an ON state by the second gate driving signal and the voltage to which the boot capacitor is charged is higher than the boot reference voltage.

15. The semiconductor device according to claim 10, wherein the voltage detection signal is supplied to the timing control circuit.

16. The semiconductor device according to claim 10, wherein the voltage detection signal is supplied to the oscillation circuit.

17. A method of controlling a DC-DC converter, comprising:
receiving a power supply voltage at an input terminal;
charging a boot capacitor to a boot voltage level;
detecting the boot voltage level; and
controlling a first driver and a second driver in accordance with a pulse signal and the detected boot voltage level.

18. The method of claim 17, wherein the first driver is supplied with power from the boot capacitor when the detected boot voltage level is greater than a reference voltage level.

19. The method of claim 17, further comprising:
comparing the detected boot voltage level to a reference voltage level and outputting a comparison signal in accordance with the comparison; and
generating a voltage detection signal based on an arithmetic operation on the comparison signal and a signal from a driver circuit connected to a low-side switch.

20. The method of claim 19, wherein the first driver switches a first nMOS transistor from an OFF state to an OFF state and the second driver switches a second nMOS transistor from an OFF state to an ON state when a level of the voltage detection signal changes; and the first driver is supplied with power from the boot capacitor when the detected voltage level is greater than a reference voltage.
